(19) United States
(12) Patent Application Publication
(10) Pub. No.: US 2013/0262663 A1
(43) Pub. Date: Oct. 3, 2013

(54) SYSTEM AND METHOD FOR PROCESSING SHAREWARE USING A HOST COMPUTER

(71) Applicants: CHIH-KUANG CHANG, Tu-Cheng (TW); XIN-YUAN WU, Shenzhen City (CN); HUA-HUI TANG, Shenzhen City (CN)

(72) Inventors: CHIH-KUANG CHANG, Tu-Cheng (TW); XIN-YUAN WU, Shenzhen City (CN); HUA-HUI TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,224

(22) Filed: Aug. 31, 2012

(30) Foreign Application Priority Data
Apr. 2, 2012 (CN) 201210095504.7

(51) Int. Cl. G06F 11/34; G06F 15/173

(52) U.S. Cl. 709/224

(57) ABSTRACT

In a method for processing shareware using a host computer, a plurality of installation modes and authorization modes are sent to a client computer if the client computer requests the host computer for a shareware installation file of the shareware in the host computer. A selected installation mode and a selected authorization mode of the client computer are determined by decrypting encrypted data from the client computer using a preset decryption formula. The method further monitors the client computer according to the selected authorization mode to determining whether the client computer is allowed to run the shareware. When the client computer runs the shareware, the method records usage status of all functions of the shareware in the client computer and receiving error reports from the client computer. The method further sends solutions to the client computer in response to the error reports.

### BACKGROUND

1. Technical Field

Embodiments of the present disclosure relate to software management, and more particularly to a system and method for processing shareware using a host computer.

2. Description of Related Art

When installing a trial edition of software (such as shareware), the software may offer limited options due to an authorization mode in a shareware installation file of the software. The shareware installation file needs to be downloaded from a host computer to a client computer for a local installation. If the client computer encounters problems during use of the software, the user of the client computer needs to report the problems by sending e-mails. In this procedure, usage status of the software cannot be made known if the computer is functioning properly and data transmission between the host computer and the client computer is not encrypted, thus, the data transmission may not be secure.

### BRIEF DESCRIPTION OF THE DRAWINGS

FIG. 1 is a block diagram of one embodiment of a host computer including a process system.

FIG. 2 is a block diagram of function modules of a process system included in the host computer of FIG. 1.

FIG. 3 is a flowchart of one embodiment of a method for processing shareware using the host computer of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module” as used herein refers to logic embodied in hardware or firmware, or to a collection of software instructions, written in a programming language, such as, Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media include compact discs (CDs), digital versatile discs (DVDs), Blu-ray disks, flash memory, and hard disk drives.

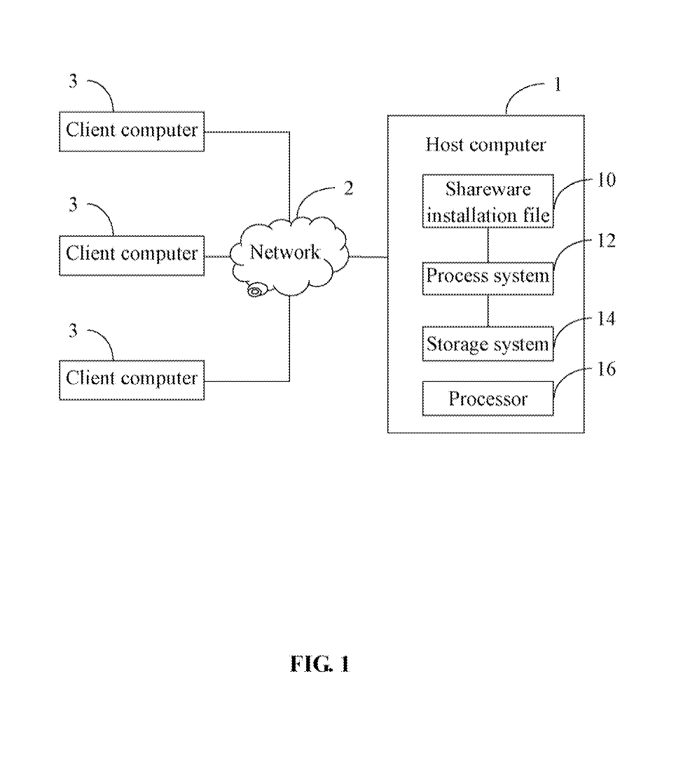

FIG. 1 is a block diagram of one embodiment of a host computer 1 including a process system 12. The host computer 1 (e.g. a server) is in communication with one or more client computers 3 (only three client computers shown in FIG. 1) through a network 2. The network 2 may be an intranet, an ethernet, or the Internet. The host computer 1 provides a shareware installation file 10 that includes shareware to install the shareware in the client computers 3. The shareware installation file 10 includes programs to generate the shareware. The client computers 3 makes a request for the shareware installation file 10 in the host computer 1 through the network 2. The process system 12 provides a plurality of installation modes and authorization modes for the client computers 3 to install the shareware, and achieves immediate knowledge of the usage of the shareware and can provide solutions in response to errors sent by the client computers 3.

The host computer 1 further includes a storage system 14 and at least one processor 16. The storage system 14 stores data of the host computer 1. The storage system 14 may be a memory (e.g., random access memory, flash memory, hard disk drive) of the host computer 1. The at least one processor 16 executes one or more computerized codes and other applications of the host computer 1, to provide functions of the process system 12.

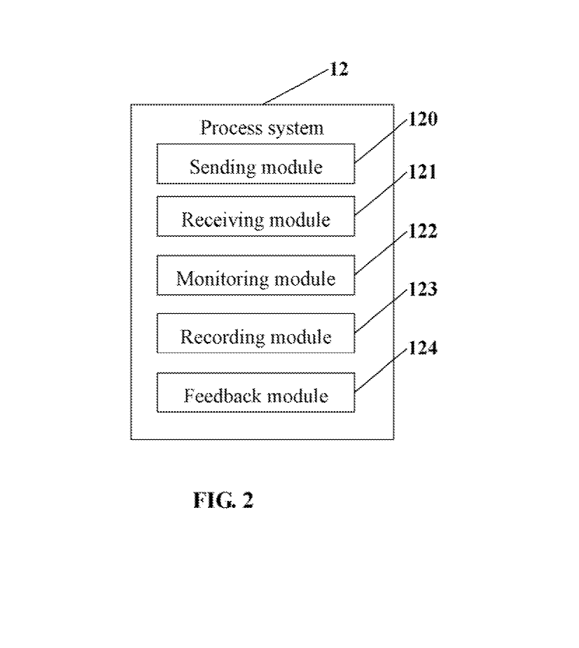

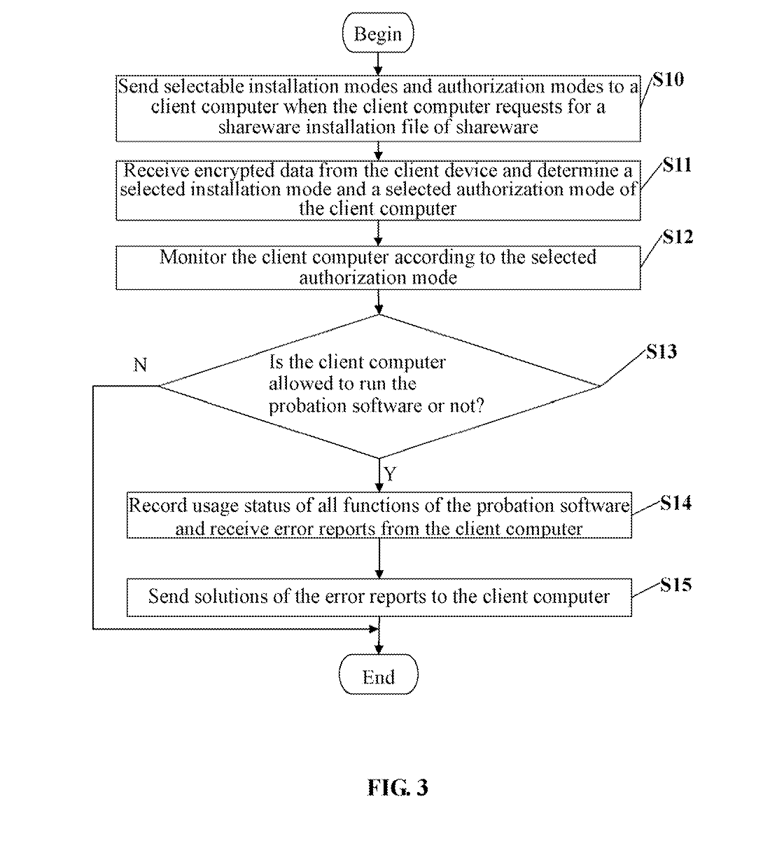

FIG. 2 is a block diagram of function modules of the process system 12 included in the host computer 1 of FIG. 1. In the embodiment, the process system 12 may include a sending module 120, a receiving module 121, a monitoring module 122, a recording module 123, and a feedback module 124. The modules 120-124 comprise computerized codes in the form of one or more programs that are stored in the storage system 14. The computerized codes include instructions that are executed by the at least one processor 16 to provide functions for the modules. Details of each of the modules will be given in FIG. 3.

FIG. 3 is a flowchart of one embodiment of a method for processing shareware using the host computer 1 of FIG. 1. Depending on the embodiment, additional steps may be added, others deleted, and the ordering of the steps may be changed.

In step S10, when the host computer 1 receives a request for the shareware installation file 10 from one of the client computers 3, the sending module 120 sends a plurality of options of installation modes and authorization modes to the client computer 3 to be selected by a user of the client computer 3. The sending module 120 may send a first message including choices of the plurality of installation modes and a second message including choices of the plurality of authorization modes to the client computer 3. The first and second messages may be displayed in a first window and a second window on a display of the client computer 3. In one embodiment, the installation modes include a first installation mode with a register file and a second installation mode without the register file. The authorization modes include a first authorization mode of time limit, a second authorization mode of use frequency, and a third authorization mode of authorization codes.

The first authorization mode represents that the client computer 3 can use the shareware for a preset period of time (e.g. one month) after the shareware has been installed in the client device 3. A usage time of the shareware starts when the shareware is installed in the client device 3. The second authorization mode represents that the client computer 3 can use the shareware a preset number of times (e.g. 50 times) after the shareware has been installed in the client device 3. When the client computer 3 runs the shareware every time, a usage frequency of the shareware is increased by one. The third authorization mode represents that the client computer 3 needs to input authorization codes to use the shareware, the authorization codes being generated by installing the shareware. In one embodiment, the third authorization mode cannot use all of functions of the shareware, that is, some functions (e.g. an upgrade function) are disabled.

After the client computer 3 selects one of the installation modes and one of the authorization modes, the client computer 3 may install the shareware using the shareware installation file 10 according to the selected installation mode. After the shareware is installed, a random encryption file is generated. The layout and content of the random encryption file may be different for each installation of the shareware. The client computer 3 may encrypt the selected installation mode and the selected authorization mode and generate encrypted data according to the random encryption file, and send the encrypted data to the host computer 1.

In one embodiment, first, the client computer 3 reads a row corresponding to a first preset character of the selected installation mode in the random encryption file, and reads a column corresponding to a second preset character of the selected authorization mode in the random encryption file. For example, if a part of the random encryption file is shown: “

| 1 | 2 | 3 | 4 | 5 | 6 | 7 | 8 | 9 | |
|---|---|---|---|---|---|---|---|---|---|
| q | w | e | r | t | y | u | i | o | p |
| a | s | d | f | g | h | j | k | l | |
| z | x | c | v | b | n | m | | | |

”, and the first preset character of the selected installation mode is “t”, and the second preset character of the selected authorization mode is “h”, then the client computer 3 reads the row of “2” corresponding to the first preset character “t” and reads the column of “6” corresponding to the second preset character “h”. The client computer 3 further calculates a new row and a new column according the read row, the read column, and a preset encryption formula. The preset encryption formula is expressed as “the new row=the read row*N+A*C, the new column=the read column *N+A*C”. “N”, “A” and “C” are preset constants. For example, if “N” is equal to 2, “A” is equal to 4, and “C” is equal to 5, the client computer 3 may calculates the new row to be 24, and calculates the new column to be 32. The client computer 3 finds a first new character of the new row in the random encryption file, and finds a second new character of the new column in the random encryption file. The client computer 3 sends the first new character and the second new character as the encrypted data to the host computer 1.

In step S11, the receiving module 121 receives the encrypted data from the client computer 3, and determines the selected installation mode and selected authorization mode of the client computer 3 by decrypting the encrypted data using a preset decryption formula. The preset decryption formula is an inverse operation of the preset encryption formula, and is expressed as “the row=(the new row−A*C)÷N, the column=(the new column−A*C)÷N”. The receiving module 121 determines the selected installation mode according to the character of the row in the random encryption file, and determines the selected authorization mode according to the character of the column in the random encryption file.

In step S12, when the client computer 3 opens the shareware, the monitoring module 122 monitors the client computer 3 according to the selected authorization mode. In one embodiment, if the first authorization mode has been selected by the client computer 3, the monitoring module 122 determines whether the usage time of the shareware in the client computer 3 is less than or equal to the preset period of time. If the second authorization mode has been selected by the client computer 3, the monitoring module 122 determines whether the usage frequency of the shareware in the client computer 3 is less than or equal to the preset number of times. If the third authorization mode has been selected by the client computer 3, the monitoring module 122 determines whether input authorization codes of the client computer 3 are the same as the authorization codes generated by installing the shareware.

In step S13, the monitoring module 122 determines whether the client computer 3 is allowed to run the shareware according to a monitor result by the monitoring module 122. If the usage time is less than or equal to the preset period of time, or the usage frequency is less than or equal to the preset usage frequency, or the input authorization codes are the same as the generated authorization codes, the monitoring module 122 allows the client computer 3 to run the shareware, and step S14 is implemented. Otherwise, if the usage time is greater than the preset period of time, or the usage frequency is greater than the preset usage frequency, or the input authorization codes are different from the generated authorization codes, the monitoring module 122 refuses (or forbids) the client computer 3 to run the shareware, and the procedure ends.

In step S14, while the client computer 3 is running the shareware, the recording module 122 records usage status of all functions of the shareware in the client computer 3 and receives error reports from the client computer 3. In one embodiment, the usage status of all functions may include a usage frequency and an error frequency of all the functions. If an error of a function of the shareware occurs in the client computer 3 (e.g. a function is unable to use), the client computer 3 may send the error as an error report to the host computer 1.

In step S15, the feedback module 124 sends solutions in response to the error reports to the client computer 3.

All of the processes described above may be embodied in, and be fully automated via, functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method of a host computer for processing shareware, the host computer in communication with a client computer through a network, the method comprising:
sending a plurality of selectable installation modes and authorization modes to the client computer upon the condition that the client computer requests the host computer for a shareware installation file of the shareware in the host computer;
receiving encrypted data of a selected installation mode and a selected authorization mode of the client computer from the client computer, and determining the selected installation mode and the selected authorization mode of the client computer by decrypting the encrypted data using a preset decryption formula;
monitoring the client computer according to the selected authorization mode when the client computer installs the shareware using the shareware installation file and opens the shareware;
determining whether the client computer is allowed to run the shareware according to the monitoring;
recording usage status of all functions of the shareware in the client computer and receiving error reports from the client computer, when the client computer is allowed to run the shareware;
sending solutions to the client computer in response to the error reports.

2. The method according to claim 1, wherein the plurality of authorization modules comprises:
a first authorization mode representing a preset period of time of using the shareware in the client computer after the shareware is installed in the client computer, a usage time of the shareware starting when the shareware is installed in the client computer;
a second authorization mode representing a preset number of times of using the shareware in the client computer after the shareware is installed in the client computer, a usage frequency of the shareware incremented by one when the client computer runs the shareware every time, and
a third authorization mode representing that the client computer inputs authorization codes to use the shareware, the authorization codes being generated by installing the shareware.

3. The method according to claim 2, further comprising:
monitoring the usage time of the shareware in the client computer to determine whether the usage time is less than or equal to the preset period of time, when the first authorization mode is selected by the client computer;
monitoring the usage frequency of the shareware in the client computer to determine whether the usage frequency is less than or equal to the preset usage frequency, when the second authorization mode is selected by the client computer;
monitoring input authorization codes from the client computer to determine whether the input authorization codes are the same as the generated authorization codes by installing the shareware, when the third authorization mode is selected by the client computer.

4. The method according to claim 3, wherein the determining step comprises:
allowing the client computer to run the shareware, if the usage time is less than or equal to the preset period of time when the first authorization mode is selected by the client computer, or the usage frequency is less than or equal to the preset usage frequency when the second authorization mode is selected, or the input authorization codes are the same as the generated authorization codes when the third authorization mode is selected;
refusing the client computer to run the shareware, if the usage time is greater than the preset period of time when the first authorization mode is selected, or if the usage frequency is greater than the preset usage frequency when the second authorization mode is selected, or if the input authorization codes are different from the generated authorization codes the third authorization mode is selected.

5. The method according to claim 1, wherein the encrypted data is generated by:
reading a row corresponding to a first preset character of the selected installation mode in a random encryption file generated by installing the shareware, and reading a column corresponding a second preset character of the selected authorization mode in the random encryption file;
calculating a new row and a new column according the read row, the read column, and a preset encryption formula, the preset encryption formula representing “the new row=the read row*N+A*C, the new column=the read column *N+A*C”, “N”, “A” and “C” being preset constants;
finding a first new character of the new row in the random encryption file, and finding a second new character of the new column in the random encryption file;
determining the first new character and the second new character as the encrypted data.

6. The method according to claim 5, wherein the preset decryption formula is an inverse operation of the preset encryption formula, and is expressed as “the row=(the new row−A*C)÷N, the column=(the new column−A*C)÷N”.

7. A non-transitory storage medium storing a set of instructions, when executed by at least one processor of a host computer, causes the at least one processor to perform a method for processing shareware using the host computer, the host computer in communication with a client computer through a network, the method comprising:
sending a plurality of selectable installation modes and authorization modes to the client computer, upon the condition that the client computer requests the host computer for a shareware installation file of the shareware in the host computer;
receiving encrypted data of a selected installation mode and a selected authorization mode of the client computer from the client computer, and determining the selected installation mode and the selected authorization mode of the client computer by decrypting the encrypted data using a preset decryption formula;
monitoring the client computer according to the selected authorization mode when the client computer installs shareware using the shareware installation file and opens the shareware;
determining whether the client computer is allowed to run the shareware according to the monitoring;
recording usage status of all functions of the shareware in the client computer and receiving error reports from the client computer, when the client computer is allowed to run the shareware;
sending solutions to the client computer in response to the error reports.

8. The non-transitory storage medium according to claim 7, wherein the plurality of authorization modules comprises:
a first authorization mode representing a preset period of time of using the shareware in the client computer after the shareware is installed in the client computer, a usage time of the shareware starting when the shareware is installed in the client computer;
a second authorization mode representing a preset number of times of using the shareware in the client computer after the shareware is installed in the client computer, a usage frequency of the shareware incremented by one when the client computer runs the shareware every time;
a third authorization mode representing that the client computer inputs authorization codes to use the shareware, the authorization codes being generated by installing the shareware.

9. The non-transitory storage medium according to claim 8, further comprising:
monitoring the usage time of the shareware in the client computer to determine whether the usage time is less than or equal to the preset period of time, when the first authorization mode is selected by the client computer;
monitoring the usage frequency of the shareware in the client computer to determine whether the usage frequency is less than or equal to the preset usage frequency, when the second authorization mode is selected by the client computer;
monitoring input authorization codes from the client computer to determine whether the input authorization codes are the same as the generated authorization codes by installing the shareware, when the third authorization mode is selected by the client computer.

10. The non-transitory storage medium according to claim 9, wherein the determining step comprises:
allowing the client computer to run the shareware, if the usage time is less than or equal to the preset period of time when the first authorization mode is selected by the client computer, or the usage frequency is less than or equal to the preset usage frequency when the second authorization mode is selected, or the input authorization codes are the same as the generated authorization codes when the third authorization mode is selected;
refusing the client computer to run the shareware, if the usage time is greater than the preset period of time when the first authorization mode is selected, or if the usage frequency is greater than the preset usage frequency when the second authorization mode is selected, or if the input authorization codes are different from the generated authorization codes the third authorization mode is selected.

11. The non-transitory storage medium according to claim 8, wherein the encrypted data is generated by:
reading a row corresponding to a first preset character of the selected installation mode in a random encryption file generated by installing the shareware, and reading a column corresponding a second preset character of the selected authorization mode in the random encryption file;
calculating a new row and a new column according the read row, the read column, and a preset encryption formula, the preset encryption formula representing “the new row=the read row*N+A*C, the new column=the read column *N+A*C”, “N”, “A” and “C” being preset constants;
finding a first new character of the new row in the random encryption file, and finding a second new character of the new column in the random encryption file;
determining the first new character and the second new character as the encrypted data.

12. The non-transitory storage medium according to claim 11, wherein the preset decryption formula is an inverse operation of the preset encryption formula, and is expressed as “the row=(the new row−A*C)÷N, the column=(the new column−A*C)÷N”.

13. A host computer in communication with a client computer through a network, comprising:
a storage system;
at least one processor; and
one or more programs that are stored in the storage system and executed by the at least one processor, the one or more programs comprising:
a sending module that sends a plurality of selectable installation modes and authorization modes to the client computer, upon the condition that the client computer requests the host computer for a shareware installation file of the shareware in the host computer;
a receiving module that receives encrypted data a selected installation mode and a selected authorization mode of the client computer from the client computer, and determines the selected installation mode and the selected authorization mode of the client computer by decrypting the encrypted data using a preset decryption formula;
a monitoring module that monitors the client computer according to the selected authorization mode when the client computer installs shareware using the shareware installation file and opens the shareware;
the monitoring module further determines whether the client computer is allowed to run the shareware according to the monitoring;
a recording module that records usage status of all functions of the shareware in the client computer and receiving error reports from the client computer, when the client computer is allowed to run the shareware;
a feedback module that sends solutions to the client computer in response to the error reports.

14. The host computer according to claim 13, wherein the plurality of authorization modules comprises:
a first authorization mode representing a preset period of time of using the shareware in the client computer after the shareware is installed in the client computer, a usage time of the shareware starting when the shareware is installed in the client computer;
a second authorization mode representing a preset number of times of using the shareware in the client computer after the shareware is installed in the client computer, a usage frequency of the shareware incremented by one when the client computer runs the shareware every time, and
a third authorization mode representing that the client computer inputs authorization codes to use the shareware, the authorization codes being generated by installing the shareware.

15. The host computer according to claim 14, wherein the monitoring module monitors the usage time of the shareware in the client computer to determine whether the usage time is less than or equal to the preset period of time, when the first authorization mode is selected by the client computer;
monitors the usage frequency of the shareware in the client computer to determine whether the usage frequency is less than or equal to the preset usage frequency, when the second authorization mode is selected by the client computer; or
monitors input authorization codes from the client computer to determine whether the input authorization codes are the same as the generated authorization codes by installing the shareware, when the third authorization mode is selected by the client computer.

16. The host computer according to claim 15, wherein the monitoring module allows the client computer to run the shareware, if the usage time is less than or equal to the preset period of time when the first authorization mode is selected by the client computer, or the usage frequency is less than or equal to the preset usage frequency when the second authorization mode is selected, or the input authorization codes are the same as the generated authorization codes when the third authorization mode is selected; or
refuses the client computer to run the shareware, if the usage time is greater than the preset period of time when the first authorization mode is selected, or if the usage frequency is greater than the preset usage frequency when the second authorization mode is selected, or if the input authorization codes are different from the generated authorization codes the third authorization mode is selected.

17. The host computer according to claim 13, wherein the encrypted data is generated by:
reading a row corresponding to a first preset character of the selected installation mode in a random encryption file generated by installing the shareware, and reading a column corresponding a second preset character of the selected authorization mode in the random encryption file;
calculating a new row and a new column according the read row, the read column, and a preset encryption formula, the preset encryption formula representing “the new row=the read row*N+A*C, the new column=the read column *N+A*C”, “N”, “A” and “C” being preset constants;
finding a first new character of the new row in the random encryption file, and finding a second new character of the new column in the random encryption file;
determining the first new character and the second new character as the encrypted data.

18. The host computer according to claim 17, wherein the preset decryption formula is an inverse operation of the preset encryption formula, and is expressed as “the row=(the new row−A*C)÷N, the column=(the new column−A*C)÷N”.
